(19) United States
(12) Patent Application Publication
(10) Pub. No.: US 2006/0274276 A1
(43) Pub. Date: Dec. 7, 2006

(54) Method and apparatus for precisely compensating skew rays and residual retardation

(75) Inventor: Arthur Berman, San Jose, CA (US)

Correspondence Address: REED SMITH, LLP, TWO EMBARCADERO CENTER, SUITE 2000, SAN FRANCISCO, CA, 94111, US

(73) Assignee: LightMaster Systems, Inc.

(21) Appl. No.: 11/143,408

(22) Filed: Jun. 1, 2005

(51) Int. Cl. G03B 21/00

(52) U.S. Cl. 353/33

(57) ABSTRACT

A greater than ¼ lambda waveplate is inserted in a light channel between a microdisplay and optics directing the light channel. The waveplate is rotated such that a main component of the retardation of the waveplate is along a skew ray axis of light from the optics, and a minor component of the retardation of the waveplate is perpendicular to a residual retardation axis of the microdisplay. The main component has a magnitude of ¼ lambda, and the minor component has a magnitude equivalent to a magnitude of residual retardation of the microdisplay.

### BACKGROUND OF THE INVENTION

1. Field of Invention

The present invention relates to compensation of light. The invention is more particularly related to compensating residual retardation and skew rays in a light channel with a waveplate of greater than ¼ lambda retardation where lambda is a central wavelength of light in the light channel.

2. Discussion of Background

In a conventional LCoS kernel quarter waveplates are positioned between the LCoS microdisplays and the Polarizing Beam Splitters (PBS). Their purpose is to increase the contrast ratio of the video image projected by the kernel. An example in the prior art is Berman et al., US Publication 2002/0001135.

### SUMMARY OF THE INVENTION

The present inventor has realized the need for more precise compensation of both skew ray and residual retardation in optical systems. Roughly described, the present invention uses a greater than ¼ lambda waveplate, which is rotated so that retardation of the waveplate along a skew ray axis is equal to ¼ lambda and retardation along a second axis has a magnitude equivalent to a residual retardation on the second axis.

In one embodiment, the present invention provides a prism assembly having a light modulator and a waveplate of greater than ¼ lambda configured to provide ¼ lambda retardation on a skew ray axis of light entering the microdisplay. The invention further provides that the configuration of the greater than ¼ lambda waveplate also provides an amount of retardation along a residual retardation axis of the microdisplay to compensate for residual retardation of the microdisplay.

In another embodiment, the present invention is a waveplate configured to compensate for first and second deviations in light rays within an optical system, wherein the waveplate is positioned in the optical system so that, a lambda value of the waveplate compensating the first deviation is ¼ lambda along an optical axis of the first deviation, and a lambda value of the waveplate compensating for the second deviation along an optical axis of the second deviation has a magnitude approximately equal a magnitude of the second deviation.

In yet another embodiment, the present invention is a microdisplay package configured for use in a lambda wavelength light channel, comprising, a microdisplay comprising an optical face, and a waveplate positioned along the optical face of the microdisplay and having an amount of retardation of greater than ¼ lambda along a main optical axis of the waveplate.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing of a waveplate illustrating a retardation axis, a skew ray axis, and a residual retardation axis;

FIG. 2 is drawing of a rotated waveplate;

FIG. 3 is a drawing of a greater than ¼ lambda waveplate rotated according to an embodiment of the present invention;

FIG. 4 is a drawing of a microdisplay package according to an embodiment of the present invention;

FIG. 5 is a drawing of a kernel in a light engine according to an embodiment of the present invention; and

FIG. 6 is a drawing illustrating orientation of a microdisplay to a waveplate according to an embodiment of the present invention.

### DESCRIPTION OF THE PREFERRED EMBODIMENTS

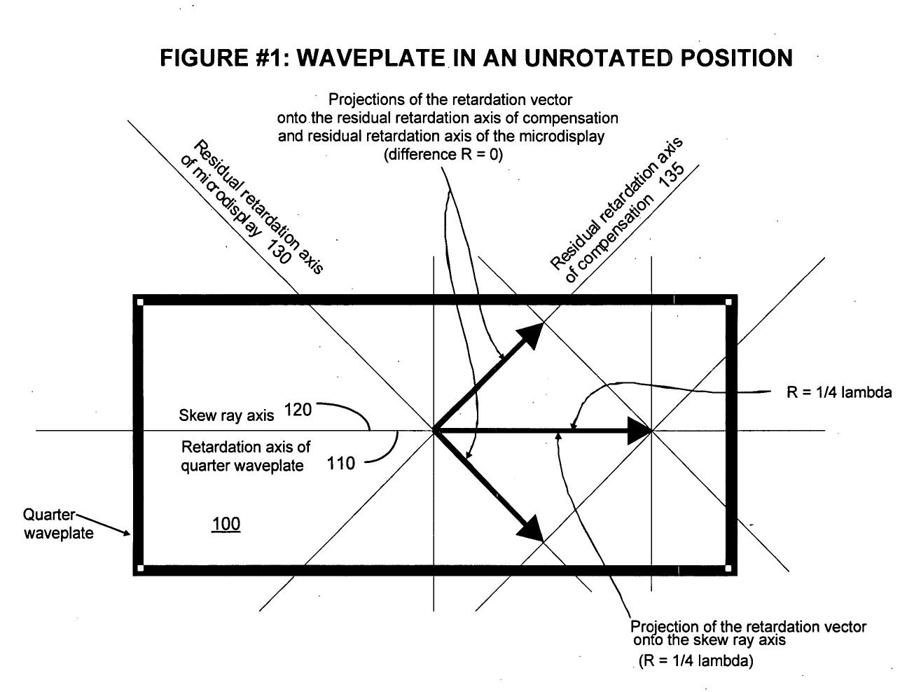

Referring now to the drawings, wherein like reference numerals designate identical or corresponding parts, and more particularly to FIG. 1 thereof, there is illustrated a drawing of a waveplate 100 illustrating a retardation axis 110, a skew ray axis 120, and a residual retardation axis 130. FIG. 1 illustrates a retardation vector R (R=¼ lambda) and projections of the retardation vector R onto a residual retardation axis of compensation 135 and onto the residual retardation axis of the microdisplay 130.

Positioning of the waveplate 100 between a microdisplay and optics in a kernel can increase a contrast ratio of a video image projected by the kernel. The positioning method works by making the dark state of the microdisplay blacker (darker). The dark state is increased through two different mechanisms.

The first mechanism is to correct geometrical depolarization of off axis light, generally caused by light rays (skew rays) transmitted off axis by the optics (e.g., a Polarizing Beam Splitter (PBS)). This is called skew ray compensation. The requirements for this mechanism to work properly are that the retardation of the waveplate be ¼ λ (λ being a central wavelength of light in a light channel in which the waveplate 100 is placed) and that the retardation axis of the waveplate be parallel to the axis of linear polarization of light rays transmitted normally by the optics (e.g., non skew rays transmitted normal to an output face of the PBS.

The second mechanism is to compensate for residual retardation in a dark state of a microdisplay operating in conjunction with the waveplate. The axis of residual retardation of a microdisplay is typically oriented 45 degrees to the mechanical edges of the microdisplay and the amount of residual retardation is “small” often on the order of several hundredths of a λ. The retardation required to compensate this residual retardation must be of a similar magnitude and oriented + or −90 degrees to the 45 degree oriented axis of residual retardation of the microdisplay.

A method for aligning the quarter waveplates in a reflective LCoS kernel is to insert quarter waveplates between the optics (e.g., PBSs) and the microdisplays set in a dark state. The waveplate are accurately fabricated having ¼ λ retardations corresponding to the center wavelength of the spectral bands utilized in each of the 3 LCoS light channels. To determine the proper orientation of the waveplate axis, light is input to the kernel and the intensity of the reflected light from each channel is observed at the output face. The axis of each waveplate is rotated until a maximum dark state is observed. The purpose and function of rotating the waveplate is to adjust the relative magnitudes of two vector components of the retardation. The first vector component is along the axes required for optimal skew ray compensation (the skew ray axis) and the second vector component is along the axis required for optimal residual retardation compensation (the residual retardation axis of compensation).

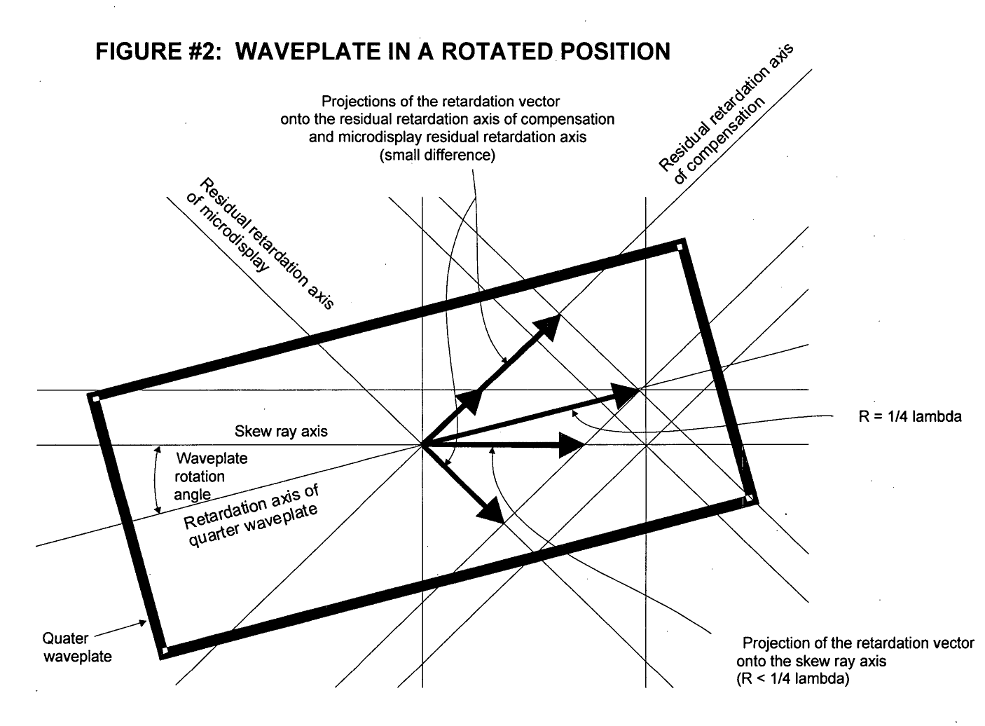

In practice it is found that system contrast ratio is a sensitive function of the waveplate rotation angle. One reason for this is that the “quality” of skew ray compensation is a sensitive function of the magnitude of the retardation along the skew ray axis. Even a small deviation from ¼ λ reduces system contrast substantially. Unfortunately, rotation of the waveplate to develop the residual retardation component does just that: reduces the magnitude of the retardation of the skew ray compensating component. This is illustrated in FIG. 2.

The present invention is not only an improved but also a practical means of compensation.

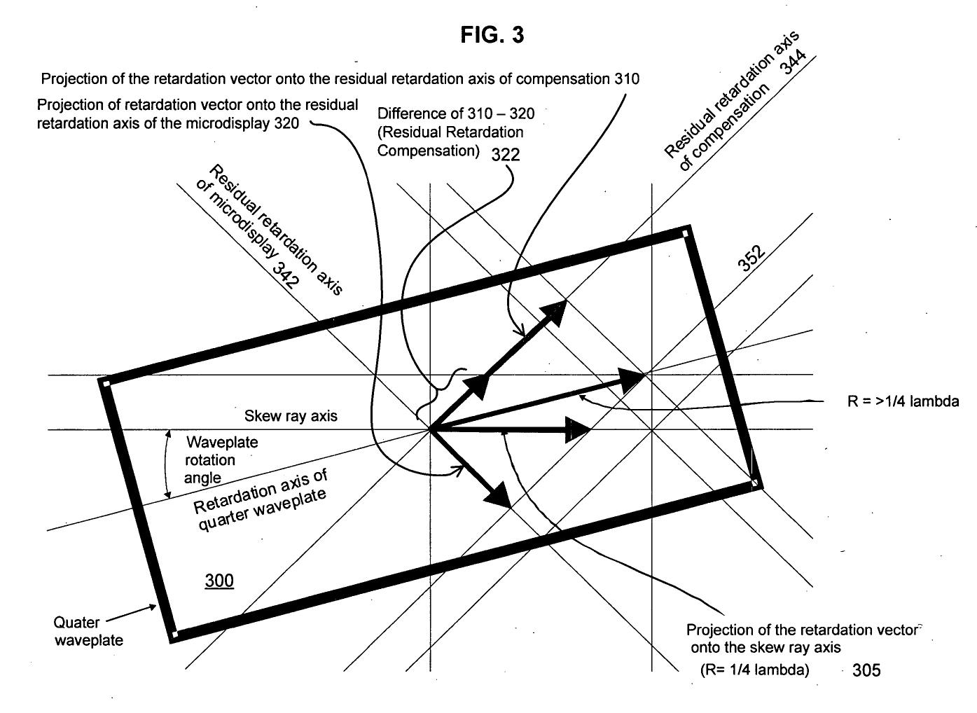

FIG. 3 is an illustration of waveplate 300 according to an embodiment of the present invention. The waveplate 300 has a retardation value greater than ¼ λ. The waveplate 300 is rotated to accomplish the best possible skew ray and residual retardation compensation within an optical system in which it is installed. In one embodiment, the specific retardation value should be such that when the waveplate is rotated, the component of the retardation falls along the residual retardation axis of compensation and accomplishes compensation related to the residual retardation axis of the microdisplay. For example, the component along the skew ray axis (component 305) is exactly ¼ λ. The component of the retardation along the residual retardation axis of compensation (resultant vector 322) (e.g., difference between 310 and 320) is used to compensate for residual retardation from the microdisplay. As a practical matter, in a multi color channel device, in each of the color channels, the waveplate should have a retardation value R in the range 0.25 λ>R<0.30 λ of the central wavelength in each of the channels.

Again, referring to FIG. 3, resolving (or projection) of the R vector to a residual retardation (rr) axis vector 320 and an rr compensation axis vector 310 highlights the resultant vector 322 which is illustrated as the small vector on the rr axis of compensation 344. In this illustration, the resultant vector 322 results from a residual retardation/residual retardation compensation addition, which, since the added vectors are at 90 degrees, cancel each other out except for the resultant vector 322 (which is the portion of the rr compensation axis vector 310 that is not cancelled out).

The R vector is also shown as resolved onto the skew ray axis and being ¼ lambda (projection 305).

One way to calculate the R and the amount of waveplate rotation is to:

(1) Start with ¼ lambda on the skew ray axis;

(2) Determine an amount/approximate amount X of desired retardation along the rr axis of compensation;

(3) Vectorily add X to the skew ray axis' ¼ lambda to produce R; and

(4) The angle between the skew ray axis and R is the amount of rotation.

In one embodiment, the present invention takes the form of prefabricated microdisplays wherein an optical window of the microdisplay is a greater than ¼ lambda waveplate rotated according to the present invention. Alternatively, a standard microdisplay is packaged with a greater than ¼ lambda rotated waveplate.

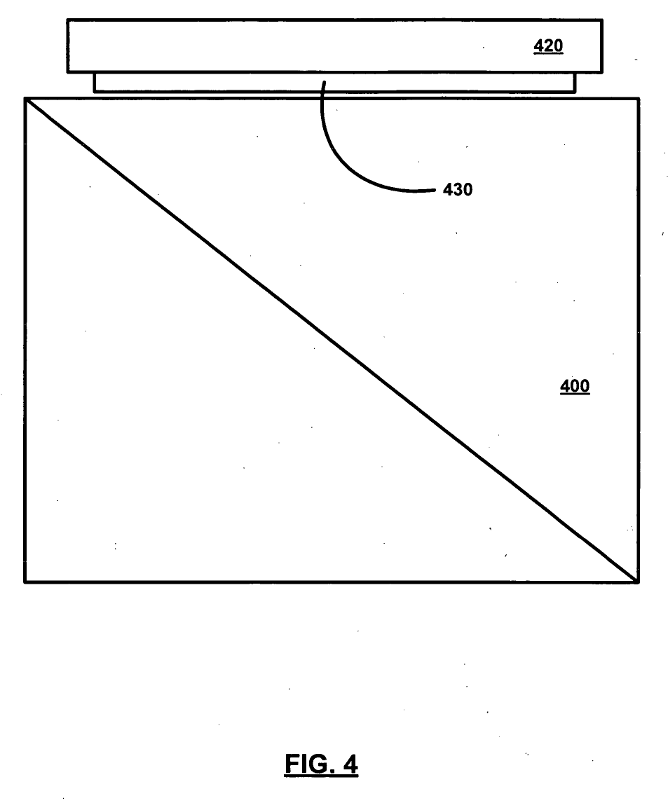

FIG. 4 is a drawing of a microdisplay package according to an embodiment of the present invention. The microdisplay package includes at least a microdisplay 420 and a waveplate 430. The waveplate 430 has greater than ¼ lambda retardation. Lambda being the central wavelength of a specific color of light on which the microdisplay package operates. In this example, the microdisplay package is mounted on a PBS 400 that is, for example, configured for use in light channel of a kernel of a projection television (not shown). The waveplate 430 is rotated such that a component of the retardation falls along a skew ray axis and has a magnitude of ¼ lambda retardation. A second component of the waveplate's retardation falls perpendicular to a residual retardation axis of the microdisplay 420 and has a magnitude approximately the same as the magnitude of residual retardation of light reflected from the microdisplay. The microdisplay is, for example, a reflective Liquid Crystal on Silicon (LCOS) microdisplay, or another type of modulator.

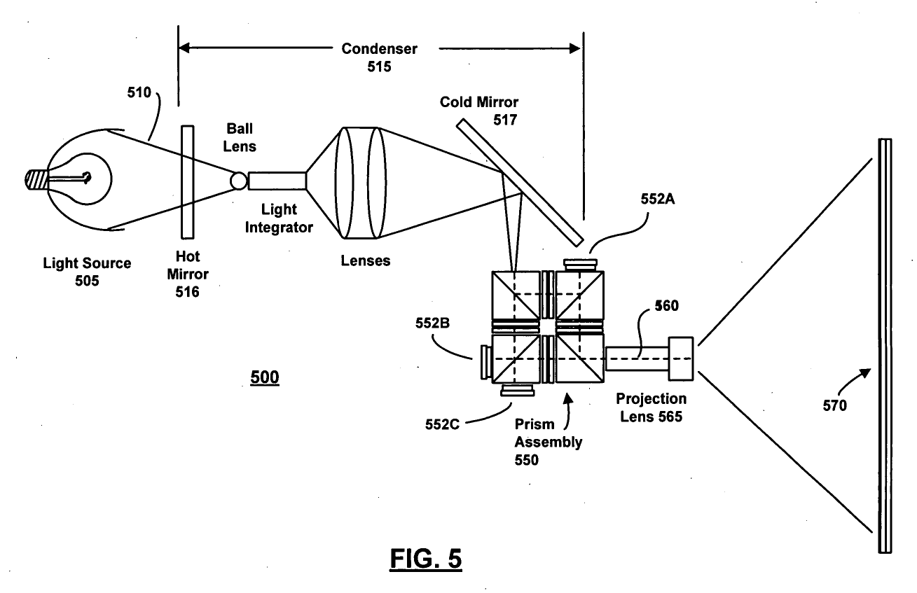

FIG. 5 is a drawing of a kernel in a light engine according to an embodiment of the present invention. A white light 510 is generated by a light source 505. The light is collected, homogenized and formed into the proper shape by a condenser 515. UV and IR components are eliminated by filters (e.g., hot/cold mirrors 516/517). The white light 510 then enters a prism assembly 550 where it is polarized and broken into red, green and blue polarized light beams. A set of reflective microdisplays are included in microdisplay packages 552A, 552B, and 552C. The microdisplay packages are provided and positioned to correspond to each of the polarized light beams (the prism assembly 550 with the attached microdisplays are referred to as a kernel). The beams then follow different paths within the prism assembly 550 such that each beam is directed to a specific reflective microdisplay. The microdisplay that interacts with (reflects) the green beam displays the green content of a full color video image. The reflected green beam then contains the green content of the full color video image. Similarly for the blue and red microdisplays. On a pixel by pixel basis, the microdisplays modulate and then reflect the colored light beams. The prism assembly 550 then recombines the modulated beams into a modulated white light beam 560 that contains the full color video image. The resultant modulated white light beam 560 then exits the prism assembly 550 and enters a projection lens 565. Finally, the image-containing beam (white light beam 160 has been modulated and now contains the full color image) is projected onto a screen 570. The screen is, for example, a screen of a High Definition (HD) Rear Projection Television (RPTV).

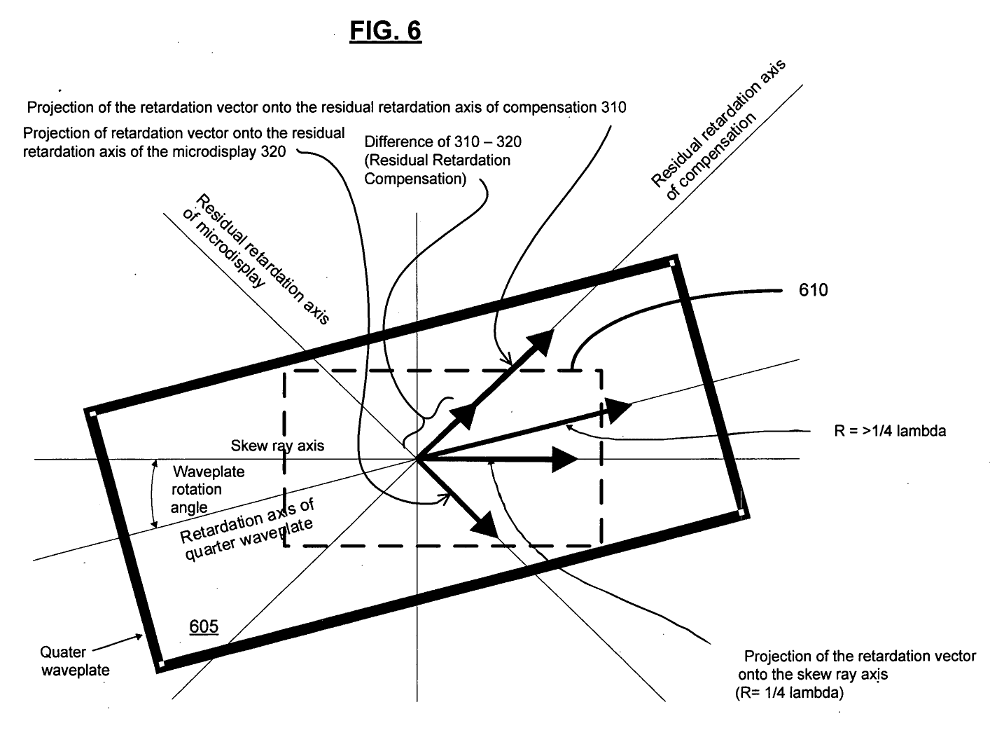

FIG. 6 is a drawing illustrating orientation of a. microdisplay optical face to a waveplate according to an embodiment of the present invention. The drawing also illustrates one method as to how a waveplate could be fabricated according to the present invention. A waveplate 605, larger than an optical face of a microdisplay is cut into a rectangular shape of the same or approximately the same dimensions as an optical face of the microdisplay. As shown in FIG. 6, the waveplate 605 is, for example, cut at the dotted line illustrating a perimeter of an optical face of a microdisplay 610. As shown in FIG. 6, the edges of the cut portion of the waveplate are either parallel or normal to the skew ray axis, and at an off normal angle to the retardation axis of the waveplate 605 and resulting cut portion of the waveplate.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. Furthermore, the inventors recognize that newly developed technologies not now known may also be substituted for the described parts and still not depart from the scope of the present invention. All other described items, including, but not limited to microdisplays, waveplates, kernels, prism assemblies, and beam splitters, etc should also be consider in light of any and all available equivalents.

The present invention may suitably comprise, consist of, or consist essentially of, any of element and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

What is claimed and desired to be secured by Letters Patent of the United States is:

1. A prism assembly, comprising:
a modulator having an axis of residual retardation;
optics configured to direct a light beam having a skew ray axis to the modulator; and
a waveplate having an axis of retardation and positioned between the optics and the modulator;
wherein the waveplate position is rotated so as to create an angle between the skew ray axis and the axis of retardation such that,
a projection of a lambda value of the waveplate from the axis of retardation onto the skew ray axis is ¼ lambda, and
a projection of the lambda value of the waveplate from the axis of retardation onto the residual retardation axis is equivalent to an amount of the residual retardation of the modulator.

2. The prism assembly according to claim 1, wherein the lambda value of the waveplate is between 0.25 lambda and 0.30 lambda.

3. The prism assembly according to claim 1, wherein the lambda value is in one of the red light, green light, and blue light wavelengths.

4. The prism assembly according to claim 1, wherein the modulator comprises a reflective liquid crystal on silicon (LCOS) microdisplay.

5. The prism assembly according to claim 1, wherein the prism assembly is part of a light engine in a projection television.

6. The prism assembly according to claim 1, wherein the modulator comprises a reflective liquid crystal on silicon (LCOS) microdisplay, and the prism assembly is part of a light engine in a High Definition (HD) projection television.

7. A waveplate configured to compensate for first and second deviations in light rays within an optical system, wherein the waveplate is positioned in the optical system so that, a lambda value of the waveplate compensating the first deviation is ¼ lambda along an optical axis of the first deviation, and a lambda value of the waveplate compensating for the second deviation along an optical axis of the second deviation has a magnitude approximately equal a magnitude of the second deviation.

8. The waveplate according to claim 7, wherein the second deviation is residual retardation in a dark state of a Liquid Crystal on Silicon (LCOS) microdisplay.

9. The waveplate according to claim 7, wherein the optical system is a quad style prism assembly.

10. The waveplate according to claim 1, wherein the waveplate is between 0.25 lambda and 0.30 lambda.

11. A microdisplay package configured for use in a lambda wavelength light channel, comprising:
a microdisplay comprising an optical face; and
a waveplate positioned along the optical face of the microdisplay and having an amount of retardation of greater than ¼ lambda along a main optical axis of the waveplate.

12. The microdisplay package according to claim 11, wherein the microdisplay package is fitted to a liquid coupled prism assembly.

13. The microdisplay package according to claim 11, wherein:
the microdisplay further comprises a residual retardation axis;
the microdisplay produces an amount of residual retardation along the residual retardation axis; and
the waveplate is rotated such an amount of the waveplate's lambda retardation along the residual retardation axis has an approximate magnitude as a magnitude of the residual retardation; and
an amount of retardation along a second axis is ¼ lambda.

14. The microdisplay package according to claim 13, wherein the lambda wavelength is one of a red, green, and blue wavelengths.

15. The microdisplay package according to claim 13, wherein the microdisplay package is a first microdisplay package fitted in a first light channel of a multi light channel prism assembly, and other light channels of the multi channel prism assembly are each respectively fitted with one each of additional microdisplay packages constructed similarly to the first microdisplay package except that each of the microdisplay packages are specifically configured for use in a lambda of the light channel in which they are fitted.
